(19) United States
(12) Patent Application Publication
(10) Pub. No.: US 2006/0022571 A1
(43) Pub. Date: Feb. 2, 2006

(54) Cathode ray tube

(76) Inventor: Youichi Itou, Mobara (JP)

Correspondence Address: Christopher E. Chalsen;Milbank, Tweed, Hadley & McCloy LLP, 1 Chase Manhattan Plaza, New York, NY, 10005-1413, US

(21) Appl. No.: 11/189,687

(22) Filed: Jul. 26, 2005

(30) Foreign Application Priority Data
Jul. 28, 2004 (JP) 2004-220449

(51) Int. Cl. H01J 29/80

(52) U.S. Cl. 313/407

(57) ABSTRACT

The present invention provides a color cathode ray tube which eliminates the generation of halation by preventing leaking of electron beams from a mask assembled body. A plate portion which projects from a skirt portion at a bent portion of a corner portion of a shadow mask is formed in an approximately fan shape which sets a width of a proximal end side thereof wider than a width of a distal end side thereof, the plate portion is joined to a planar portion of a mask frame by welding, and gaps defined between the planar portion and the bent portion are closed by the plate portion.

### BACK GROUND OF THE INVENTION

1. Field of the Invention

The present invention relates to a color cathode ray tube, and more particularly to a color cathode ray tube which prevents leaking of beam between a color selection electrode and a maskframe which holds the color selection electrode.

2. Description of the Related Art

A color cathode ray tube, for example, a shadow-mask-type color cathode ray tube which is used in a color television set, a color display monitor for an OA equipment terminal or the like forms a vacuum envelope which is constituted of an approximately rectangular panel portion which has a phosphor screen including a large number of dot-like or stripe-like phosphor pixels on an inner surface thereof, an approximately cylindrical-shape neck portion which houses an electron gun therein and a funnel portion which connects the neck portion and the above-mentioned panel portion on an axis which is substantially coaxial with a tube axis. A shadow mask which constitutes a color selection electrode is arranged in the vicinity of and facing the phosphor screen in the inside of the vacuum envelope. Further, the shadow mask has a large number of electron beam apertures on a surface thereof which faces the phosphor screen, while a skirt portion of the shadow mask is fixed to a rectangular mask frame having an approximately L-shaped cross section.

The shadow mask uses an aluminum killed steel as a main constituting material thereof. Further, along with a recent demand for high definition of the color cathode ray tube, a plate thickness of the shadow mask is decreased. In a color cathode ray tube which adopts the thin-plate-thickness shadow mask, a phenomenon in which a portion of the shadow mask is deformed by heat so that an electron beam spot is displaced from a given position on a phosphor surface during a displaying operation, that is, a so-called mask doming phenomenon is liable to easily occur.

To cope with such a phenomenon, a shadow mask suspension mechanism has been improved or an Invar material is adopted as a constitutional material of the shadow mask.

Such a shadow mask is formed as follows. A form in which a large number of the above-mentioned electron beam apertures are formed at given positions by etching is blanked in a predetermined shape. Thereafter, the blanked form is formed by press shaping into a shape constituted of an approximately spherical main surface and a skirt portion which is contiguously formed with a periphery of the main surface and is bent by approximately 90 degrees with respect to the main surface. The shaped shadow mask is fixed to the above-mentioned rectangular mask frame thus forming a mask assembled body to be used.

FIG. 8 and FIG. 9 are schematic plan views for explaining the constitution of the mask assembled body. FIG. 8 shows an axial-pin-type shadow mask assembled body which includes engaging springs 71 in the vicinity of centers of respective sides of the approximately rectangular shadow mask 51. This constitution represents the conventional main-stream structure. On the other hand, FIG. 9 shows a corner-pin-type shadow mask assembled body which includes engaging springs 72 on respective corner portions of the approximately rectangular shadow mask 52. The corner-pin-type mask assembled body is characterized in that the enhancement of the holding strength of the shadow mask inside a tubular bulb can be expected. Here, numerals 51a and 52a respectively indicate electron beam apertures formed in the above-mentioned main surface.

FIG. 10 and FIG. 11 are schematic plan views for explaining the constitution of the corner-pin-type mask assembled body, wherein a portion “A” in FIG. 9 is shown in an enlarged manner and the engaging spring 72 is omitted. First of all, FIG. 10 shows the constitution in which both of the shadow mask 52 and the mask frame 61 have planar portions (straight line portions) 52b, 61b at corner portions. The planar portions 52b and 61b are configured to face each other in an opposed manner parallel to a tube axis. The respective planar portions 52b, 61b are provided to respective corners in a state that these planar portions 52b, 61b are arranged to face each other parallel to the tube axis and are connected with respective long and short sides of the shadow mask 52 and the mask frame 61 at bent portions 52c, 61c.

The constitution which provides the planar portion to the corner portion is disclosed in, for example, U.S. Pat. No. 4,599,533 specification (patent literature 1), Japanese Patent Laid-open Sho63(1988)-200436 (patent literature 2) and the like. Here, in these patent literatures 1 and 2, the engaging springs are illustrated in the axial pin-type arrangement.

Next, a shadow mask assembled body shown in FIG. 11 includes an arcuate bent portion 51c in the circumferential direction at a corner portion 51b of a shadow mask 51. FIG. 12 shows an example of such a constitution of the shadow mask assembled body. That is, only the mask frame 61 to be assembled has the planar portions 61b as mentioned above. Provided that the planar portion 61b adopts the constitution which fixedly mounts the engaging spring 72 thereon, the flatness of the inner and outer side surfaces becomes important.

The shadow mask 51 shown in FIG. 12 includes a main surface 51d which has electron beam apertures 51a, a skirt portion 51e which is contiguously formed with a periphery of the main surface 51d and is bent with respect to the main surface 51d by approximately 90 degrees, and plate portions 51g each of which is arranged by forming slits 51f at both ends in the circumferential direction in the skirt portion 51e at each corner portion 51b. The plate portion 51g has a length L1 and a width W1, wherein the width W1 is set to an approximately same size from a proximal end to a distal end thereof.

Here, FIG. 12 is a schematic perspective view showing one example of the shaped shadow mask. The plate portion 51g of the shadow mask 51 is, as shown in FIG. 13, joined by welding to an inner side surface of the planar portion 61b of the above-mentioned mask frame 61 at a point indicated by a mark x thus forming a mask assembled body. Here, FIG. 13 is a schematic perspective view showing one example of the mask assembled body, wherein parts identical with the parts shown in the above-mentioned drawings are given the same symbols.

### SUMMARY OF THE INVENTION

Among the corner-pin-type mask assembled bodies, with respect to the mask assembled body which includes the planar portions 52b, 61b at the corner portions together with the shadow mask 52 and the mask frame 61, at portions of the bent portions 52c which contiguously join the respective long and short sides and the planar portions 52b at the time of mask shaping operation, cuts and wrinkles on the material attributed to shaping occur and these cuts and wrinkles give rise to practical problems.

Particularly, since the shadow mask is formed by forming a large number of electron beam apertures in a thin plate having a thickness of approximately 0.1 to 0.2 mm, the above-mentioned problems arise at the time of performing the press shaping and there has been a demand for measures to overcome the problems.

On the other hand, with respect to the constitution shown in FIG. 11 in which the corner portion 51b of the shadow mask 51 includes the arcuate bent portion 51c in the circumferential direction, the constitution is the mask shaping structure which has achieved satisfactory results in the past and hence, the above-mentioned drawbacks do not exist. However, leaking of electron beams occurs between the shadow mask and the mask frame of the mask assembled body and there exists a drawback that the image quality is degraded due to the halation attributed to the leaking of electron beams and there has been a demand for measures to overcome the drawback. In general, in a cathode ray tube, for example, in a color cathode ray tube, so-called over-scanning which scans the electron beams outside a width of a main surface of a shadow mask is performed.

In the mask assembled body having the constitution shown in FIG. 13, the electron beams which are irradiated from an electron gun and advance to a phosphor screen are scanned in a wide range covering side walls of the mask frame 61 exceeding a width of the main surface 51d of the shadow mask 51. Due to such scanning, at the above-mentioned corner portion, the electron beams leak to the phosphor screen side from a slit 51f portion arranged close to a plate portion 51. The leaked electron beams pass through the slit 51f portion and, thereafter, as shown in FIG. 14, pass through gaps S which are formed between the planar portion 61b of the mask frame 61 and the curved surface 51c of the shadow mask 51. Then, the electron beams impinge on the phosphor screen and make the phosphor screen emit light thus generating the halation on a normal image. Here, FIG. 14 is a schematic plan view showing an essential part of FIG. 13 in an enlarged manner.

Accordingly, it is an object of the present invention to provide an excellent color cathode ray tube which can overcome the above-mentioned drawbacks and can eliminate the generation of halation by preventing the leaking of electron beams from a mask assembled body.

To describe typical constitutions of the present invention, they are as follows. That is, the present invention provides a color cathode ray tube which includes a color selection electrode having an approximately rectangular main surface having a plurality of electron beam apertures, a skirt portion which is bent in the direction toward a neck portion from the main surface, and plate portions which are arranged at corner portions and project from the skirt portion in the direction away from the main surface, and an approximately rectangular mask frame which holds the color selection electrode. Further, the mask frame has planar portions at the respective corner portions which face a tube axis in parallel and is fixed to the plate portion at these planar portions. The plate portion of the color selection electrode substantially close gaps defined between the plate portion and mask frame at the corner portions.

The color cathode ray tube according to the present invention is constituted of a vacuum envelope which includes an approximately rectangular panel portion which forms a phosphor film on an inner surface thereof, a neck portion which houses an electron gun therein, and a funnel portion which connects the neck portion and the panel portion on an axis which is substantially coaxial with a tube axis. In the inside of the vacuum envelope, a shadow mask assembled body is arranged to face the phosphor film. The shadow mask assembled body includes a shadow mask (or also referred to as a color selection electrode) which forms a plurality of electron beam apertures in a rectangular main surface, and an approximately rectangular mask frame which holds the shadow mask. The shadow mask includes an approximately rectangular main surface which faces the phosphor film in an opposed manner and includes a plurality of electron beam apertures, a skirt portion which is bent in the direction toward the neck portion from the main surface, plate portions which are arranged at the corner portions and project in the direction away from the main surface. The mask frame includes planar portions which face a tube axis in parallel at corner portions thereof and the mask frame is fixed to the plate portions at the planar potion. Further, the plate portions of the color selection electrode substantially close gaps defined between the plate portion and the mask frame at the corner portion thereof.

Due to such a constitution, it is possible to prevent the leaking of electron beams from the shadow mask assembled body and hence, the generation of halation can be suppressed whereby the color cathode ray tube which exhibits the high quality can be obtained.

Further, the corner portions of the color selection electrode which face the planar portions of the mask frame include arcuate bent portions. The plate portion which extends in the direction toward the electron gun from the corner portion has a curved surface. Due to such a constitution, the cutting of material or the generation of wrinkles at the time of performing the shadow mask shaping can be eliminated and hence, the shadow mask which exhibits the high definition can be obtained at a low cost.

Further, a width of the plate portion of the color selection electrode differ between a proximal end which is close to the main surface and a distal end thereof, or the plate portion of the color selection electrode has a width in the circumferential direction of a proximal end thereof set smaller than a width in the circumferential direction of a distal end thereof. Due to such a constitution, it is possible to close the gaps defined between the planar portions of the mask frame and the shadow mask using the plate portions and hence, it is possible to prevent the leaking of electron beams from the mask assembled body.

Further, a width of the plate portion along a curved surface is set equal to or more than 80% of a width of an arcuate bent portion at the corner portion of the color selection electrode, or the expansion of the plate portion from a distal end side to a proximal end side is within a range of 3° to 10°. Due to such a constitution, along with the prevention of the leaking of the electron beams from the mask assembled body, it is possible to efficiently perform the shadow mask shaping operation.

Further, the plate portion has a curved surface. Due to such a constitution, the mechanical strength of the plate portion is enhanced and hence, it is possible to efficiently perform the shadow mask shaping operation.

Further, the mask frame includes an engaging spring on an outer surface of the planar portion of the corner portion. Due to such a constitution, it is possible to enhance the holding strength of the mask assembled body in a tube bulb.

### BRIEF DESCRIPTION OF THE SEVERAL VIEWS OF THE DRAWING

FIG. 1 is a cross-sectional view for explaining an example of the whole structure of one embodiment of a shadow-mask-type color cathode ray tube according to the present invention;

FIG. 2 is a plan view of one example of the mask assembled body which is used in the color cathode ray tube according to the present invention;

FIG. 3 is a cross-sectional view taken along a line I-I in FIG. 2;

FIG. 4 is a perspective view of an essential part shown in FIG. 2;

FIG. 5 is a perspective view of one example of a shadow mask used in the color cathode ray tube according to the present invention;

FIG. 6 is a plan view of an essential part showing one example of a shadow mask form used in the color cathode ray tube according to the present invention;

FIG. 7 is a plan view of an essential part showing one example of a mask assembled body used in the color cathode ray tube according to the present invention;

FIG. 8 is a plan view of one example of a mask assembled body used in a color cathode ray tube;

FIG. 9 is a plan view of another example of the mask assembled body used in a color cathode ray tube;

FIG. 10 is a schematic plan view of one example of the mask assembled body showing a portion “A” in FIG. 9 in an enlarged manner;

FIG. 11 is a schematic plan view of another example of the mask assembled body showing the portion “A” in FIG. 9 in an enlarged manner;

FIG. 12 is a schematic perspective view of one example of a shaped shadow mask which is used in the color cathode ray tube;

FIG. 13 is a schematic perspective view showing one example of a mask assembled body used in the color cathode ray tube; and

FIG. 14 is a schematic plan view showing an essential part in FIG. 13 in an enlarged manner.

### PREFERRED EMBODIMENTS OF THE PRESENT INVENTION

Preferred embodiments of the present invention are explained hereinafter in conjunction with drawings which show the embodiments.

### Embodiment 1

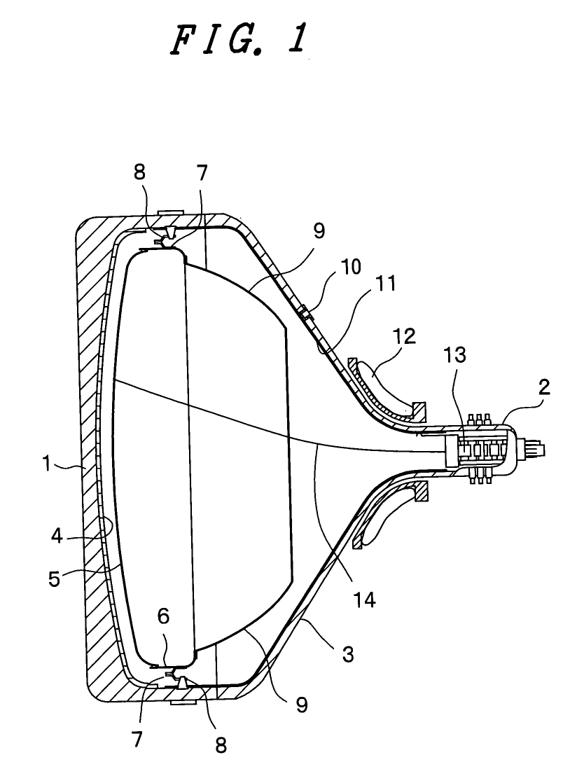

FIG. 1 is a cross-sectional view for explaining an example of the whole structure of one embodiment of a shadow-mask-type color cathode ray tube according to the present invention. In FIG. 1, numeral 1 indicates a panel portion, numeral 2 indicates a neck portion, numeral 3 indicates a funnel portion, numeral 4 indicates a phosphor film, numeral 5 indicates a shadow mask which forms a large number of electron beam apertures therein and constitutes a color selection electrode, and numeral 6 indicates a mask frame which has the structure described later and fixes and holds the shadow mask 5.

Numeral 7 indicates an engaging spring, numeral 8 indicates panel pins, numeral 9 indicates a magnetic shield, numeral 10 indicates an anode button, numeral 11 indicates an interior conductive film, numeral 12 indicates a deflection yoke which deflects electron beams horizontally and vertically, and numeral 13 indicates an electron gun which irradiates three electron beams 14 (one center electron beam and two side electron beams). The mask assembled body is constituted of the shadow mask 5, the mask frame 6 and the engaging springs 7.

In the drawing, the panel portion 1 having a phosphor film 4 on an inner surface thereof and the neck portion 2 housing the electron gun 13 are joined by a funnel portion 3. Further, a bulb which is constituted of the panel portion 1, the funnel portion 3 and the neck portion 2 has an inside thereof evacuated and sealed. In the inside of the bulb, the mask frame 6 which fixes the shadow mask 5, the magnetic shield 9 and the like thereto is suspended by panel pins 8 using the engaging springs 7. The panel portion 1 and the funnel portion 3 are fixed to each other by welding using frit glass.

The electron beams 14 which are irradiated from the electron gun 13 receive the deflection in two directions consisting of the horizontal direction and the vertical direction by the deflection yoke 12 which is mounted on a transitional portion between the neck portion 2 and the funnel portion 3, pass through the electron beam apertures formed in the shadow mask 5 which constitutes the color selection electrode and impinge on the phosphor film 4 thus forming an image.

The shadow mask 5 is a mask which is shaped to a given curved surface by performing the press shaping of a shadow mask form which is obtained by forming the electron beam apertures therein by etching a thin film made of an Invar material (Fe-36% Ni), wherein the shadow mask 5 is curved in conformity with an inner surface of the panel portion 1.

The shadow mask 5 has an approximately rectangular apertured area (main surface) where a large number of electron beam apertures are formed, wherein the shadow masks having various specifications which differ in respective radii of curvature along a long axis, along a short axis and along a diagonal line are provided. These specifications can satisfy both of a flat feeling of a screen of the color cathode ray tube and the maintenance of a mechanical strength of the shaped shadow mask.

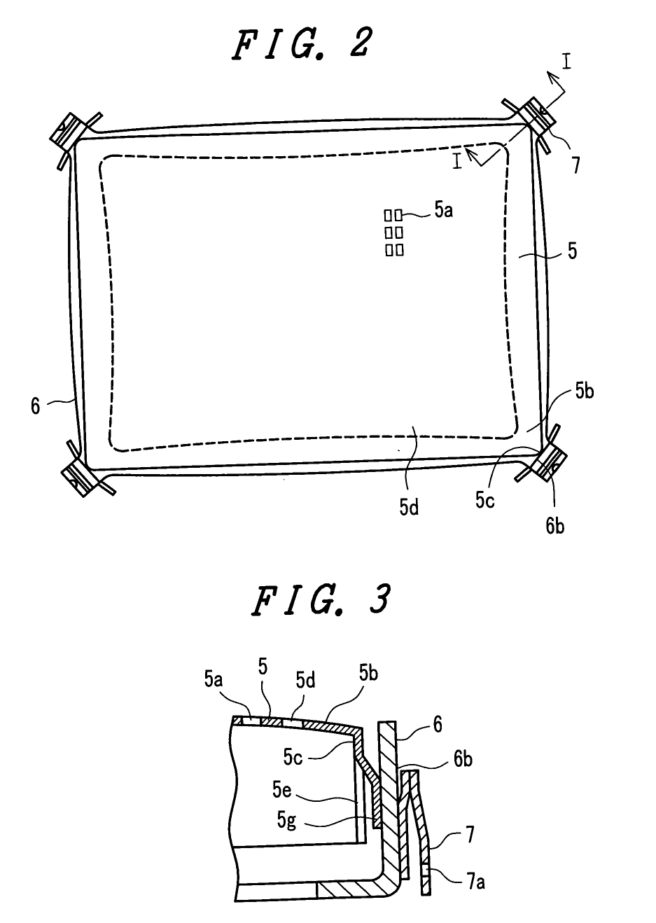

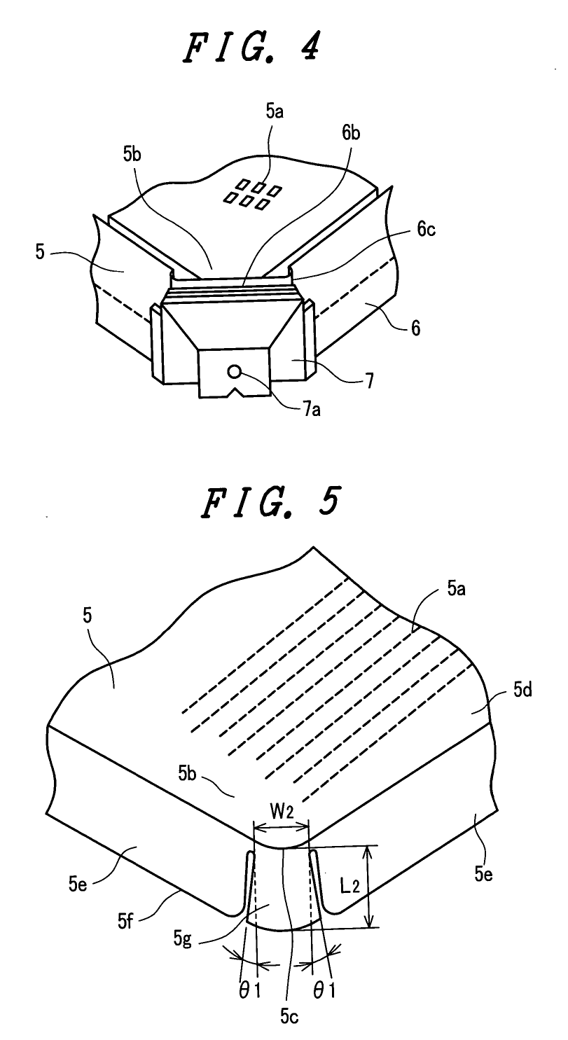

FIG. 2 to FIG. 4 are views for explaining one example of the mask assembled body used in the color cathode ray tube of the present invention, wherein FIG. 2 is a plan view of the mask assembled body, FIG. 3 is a cross-sectional view taken along a line I-I in FIG. 2, and FIG. 4 is a perspective view of an essential part shown in FIG. 2. Parts identical with the parts in the previously-mentioned drawing are given the same symbols.

In FIG. 2 to FIG. 4, numeral 5a indicates the electron beam apertures formed in the shadow mask 5, numeral 5b indicates a corner portion of the shadow mask 5, numeral 5c indicates an arcuate curved surface in the circumferential direction of the corner portion 5b of the shadow mask 5, numeral 5d indicates a main surface of the shadow mask 5, numeral 5e indicates a skirt portion of the shadow mask 5, numeral 5g indicates a plate portion of the corner portion 5b, numeral 6b indicates a planar portion of the mask frame 6, numeral 6c indicates frame corner portions at both ends of the planar portion 6b, and numeral 7a indicates a spring engaging hole for the engaging spring 7.

The main surface 5d of the shadow mask 5 includes a large number of electron beam apertures 5a on a portion thereof which faces the phosphor film on an inner surface of the panel portion. Further, the skirt portion 5e is arranged at long and short sides of an outer peripheral portion of the main surface 5d and is bent with respect to the main surface 5d at an approximately right angle. The skirt portion 5e is further joined by welding to the mask frame 6 at a plurality of portions in the circumferential direction. The plate portion 5g which is provided to the corner portion 5b of the shadow mask 5 is joined by welding to the planar portion 6b of the mask frame 6. The engaging spring 7 is joined by welding to an outer side surface of the planar portion 6b and the mask assembled body is mounted in the inside of the panel portion 1 by allowing the engaging spring 7 to be engaged with the above-mentioned panel pin 8.

Next, FIG. 5 is a schematic perspective view of one example of the shadow mask used in the color cathode ray tube according to the present invention, wherein parts identical with the parts shown in the previously-mentioned drawings are given the same symbols. In FIG. 5, the shadow mask 5 includes the main surface 5d which has the electron beam apertures 5a, the skirt portion 5e which is contiguously formed with a periphery of the main surface 5d and is bent with respect to the main surface 5d by approximately 90 degrees, and plate portions 5g each of which is arranged by forming slits 5f at both ends in the circumferential direction in the skirt portion 5e at each corner portion 5b. The plate portion 5g has a length L2, while a width thereof is set to W2 at a proximal end thereof and W3 at a distal end thereof. Further, the width of the plate portion 5g has the relationship W2<W3. Further, the plate portion 5g has a curved surface having a radius of curvature equal to an arcuate portion of the bent portion 5c of the corner portion 5b. Due to such a curved surface, the mechanical strength of the plate portion 5g is enhanced. Further, by setting the width W2 to 80% to 100%, preferably 80% to 90% of the arc of the bent portion 5c of the corner portion of the shaped shadow mask 5, the electron beam leaking preventing function can be further effectively performed. When the width W2 exceeds 100% of the arc of the bent portion 5c, the cuts and the wrinkles occur in the skirt portion 5e and hence, the shaping efficiency is lowered.

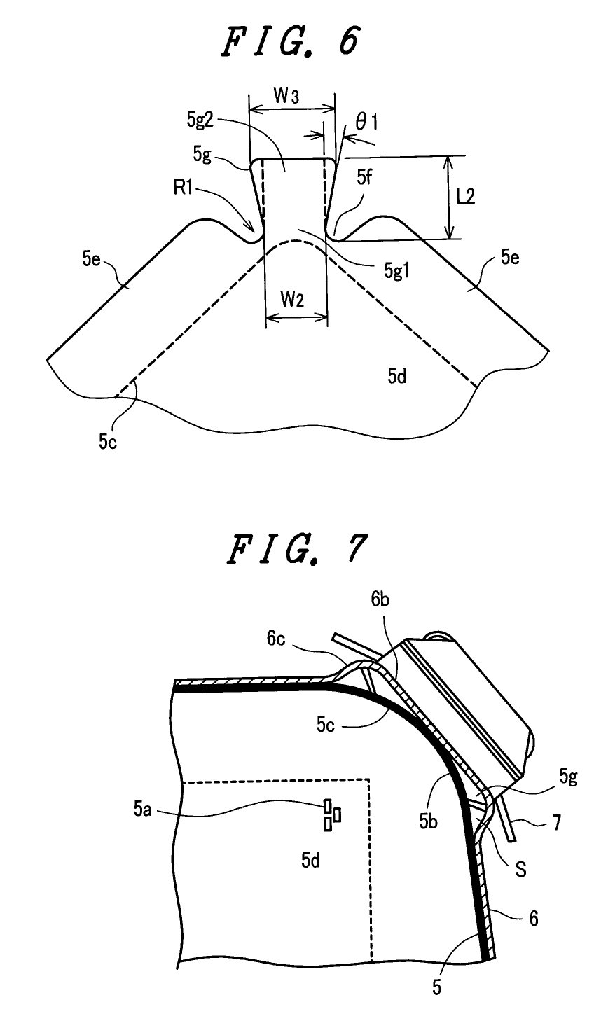

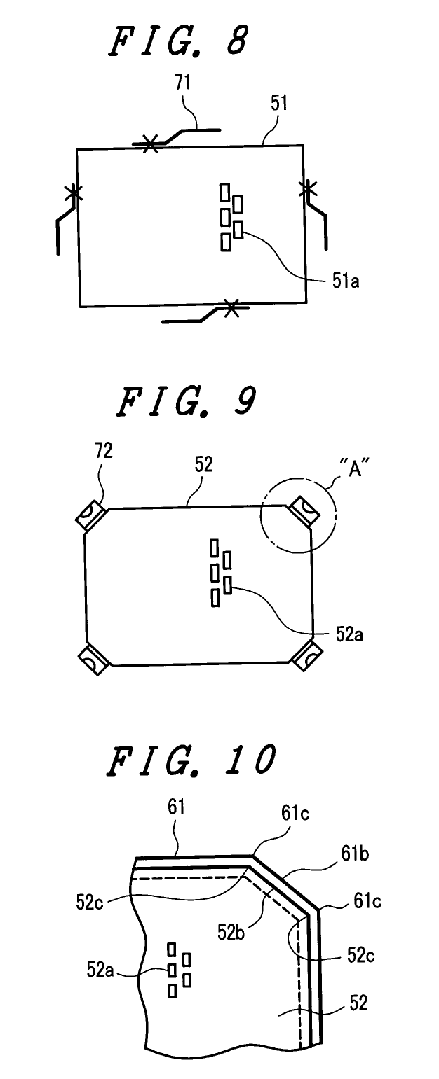

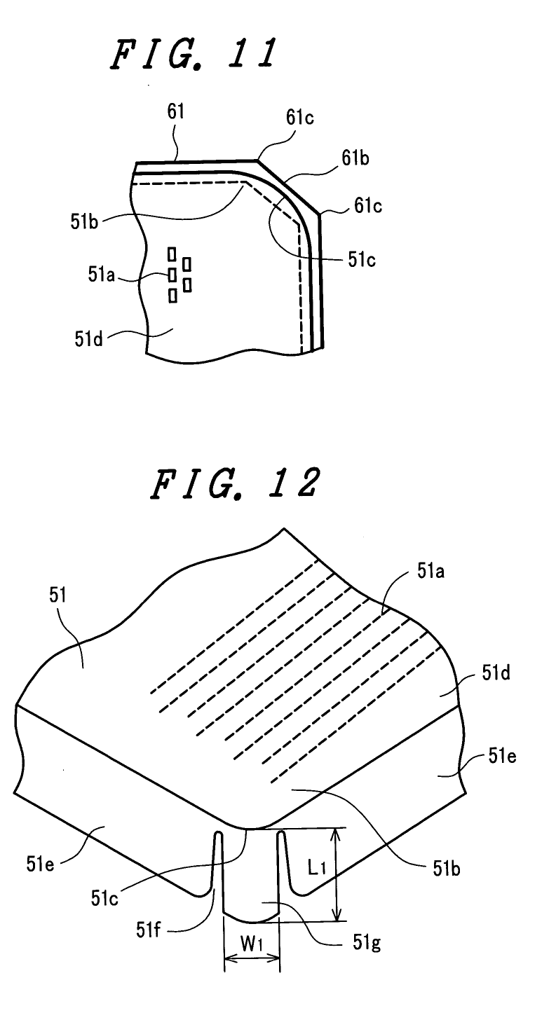

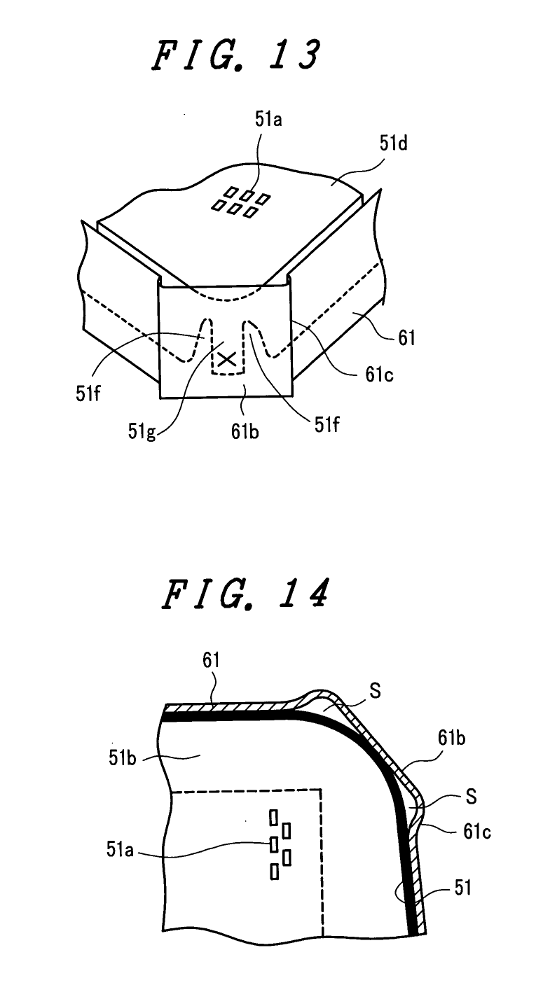

Next, FIG. 6 is a schematic plan view of the shadow mask form before performing the shaping of the shadow mask 5, wherein parts identical with the parts shown in the previously-mentioned drawings are given the same symbols. In FIG. 6, the plate portion 5g exhibits a sector, wherein the width thereof is set to W2 at a proximal end 5g1 thereof and W3 at a distal end 5g2 thereof, and the width of the plate portion 5g has the relationship W2<W3. Provided that the relationship W2<W3 is satisfied, it is preferable that an expanding angle θ1 falls within the range of 3° to 10°. Further, a radius of curvature of a curved surface R1 of the slit 5f between the proximal end side 5g1 and the skirt portion 5e is limited to approximately 1 to 3 mm. When the radius of curvature R1 of the bottom of slit assumes a size smaller than the size or the angle θ1 exceeds 10°, the plate portion 5g and the skirt portion 5e overlap each other in the inside of a shaping mold when the shaping of the shadow mask 5 is performed thus giving rise to possibilities that the defective shaping occurs or the shaped mask cannot be taken out from the shaping mold.

The shadow mask shaping is performed such that the skirt portion 5e and the plate portions 5g are bent from the main surface 5d at an approximately 90 degrees at the bent portion 5c indicated by a dotted line thus finishing the shadow mask 5 in a shape shown in FIG. 5. As a specific example of sizes of the plate portion 5g, to take a 29-inch color cathode ray tube as an example, they are W2: 23 mm, W3: 24.5 mm, L2: 26 mm, θ1: 30, R1: 1 mm respectively.

Next, FIG. 7 is a schematic plan view of the mask assembled body of one example of the color cathode ray tube of the present invention, wherein parts identical with the parts shown in the previously-mentioned embodiment are given the same symbols. In FIG. 7, between the planar portion 6b of the mask frame 6 and the curved portion 5c of the corner portion 5b of the shadow mask 5, an approximately sector-shaped plate portion 5g extending from the main surface 5d side is extended and arranged substantially parallel to the above-mentioned planar portion 6b, and the plate portion 5g is fixed to the planar portion 6b by welding joining. The plate portion 5g has the width which is increased toward the distal end side from the proximal end side as mentioned above and closes gaps S defined between the planar portion 6b and the bent portion 5c.

The present invention is not limited to the above-mentioned embodiment and various modifications are conceivable without departing from the technical concept of the present invention.

What is claimed is:

1. A color cathode ray tube comprising;
a vacuum envelope which includes an approximately rectangular panel portion which forms a phosphor film on an inner surface thereof, a neck portion which houses an electron gun therein, and a funnel portion which connects the neck portion and the panel portion on an axis which is substantially coaxial with a tube axis;
a color selection electrode which includes an approximately rectangular main surface which faces the phosphor film in an opposed manner and includes a plurality of electron beam apertures, a skirt portion which is bent in the direction toward the neck portion from the main surface, plate portions which are arranged at corner portions and project in the direction away from the main surface;
an approximately rectangular mask frame which holds the color selection electrode; wherein,
the mask frame includes planar portions which face a tube axis in parallel at corner portions thereof and the mask frame is fixed to the plate portions at the planar potions, and
the plate portion of the color selection electrode substantially close gaps defined between the plate portion and the mask frame at the corner portion thereof.

2. A color cathode ray tube according to claim 1, wherein the corner portions of the color selection electrode which face the planar portions of the mask frame include arcuate bent portions.

3. A color cathode ray tube according to claim 1, wherein a width of the plate portion of the color selection electrode differ between a proximal end and a distal end thereof.

4. A color cathode ray tube according to claim 1, wherein the plate portion of the color selection electrode has a width of a proximal end thereof set smaller than a width of a distal end thereof.

5. A cathode ray tube according to claim 1, wherein a width of the plate portion is equal to or more than 80% of a width of an arcuate bent portion at the corner portion of the color selection electrode.

6. A color cathode ray tube according to claim 1, wherein the expansion of the plate portion from a distal end to a proximal end is within a range of 3° to 10°.

7. A color cathode ray tube according to claim 1, wherein the plate portion has a curved.

8. A color cathode ray tube according to claim 1, wherein the mask frame includes an engaging spring on an outer surface of the planar portion of the corner portion.
